(19) United States
(12) Patent Application Publication
(10) Pub. No.: US 2004/0035104 A1
(43) Pub. Date: Feb. 26, 2004

(54) Device for the continuous adjustment of unbalance of steerable vibration plates

(76) Inventors: Josef Sollinger, Mallersdof-Pfaffenberg (DE); Norbert Jungwirth, Unterschleissheim (DE)

Correspondence Address: BOYLE FREDRICKSON NEWHOLM STEIN & GRATZ, S.C., 250 E. WISCONSIN AVENUE, SUITE 1030, MILWAUKEE, WI, 53202, US

(21) Appl. No.: 10/416,874

(22) PCT Filed: Nov. 21, 2001
(86) PCT No.: PCT/EP01/13557

(30) Foreign Application Priority Data
Nov. 22, 2000 (DE) 200 19 823.8

(51) Int. Cl. F16D 31/02

(52) U.S. Cl. 60/484

(57) ABSTRACT

The invention relates to steerable vibration plates that are set vibrating by rotating unbalanced masses. By twisting the unbalanced masses relative to one another the resulting forces and their direction of action can be changed, thereby influencing the travel speed of the vibrating plate and its direction of travel. The inventive vibration plate is characterized in that the unbalanced masses disposed on a common shaft can be adjusted independent of external forces and torques since the adjustment piston adjusting the unbalanced masses is braced in the adjustment cylinder to a much higher degree than would be possible with conventional coil springs. To this end, every adjustable unbalanced mass is associated with a double-action hydraulic cylinder that comprises two liquid chambers. The connection of said chambers to a storage and a pump can be locked in order to fix the piston which can be adjusted within the hydraulic cylinder.

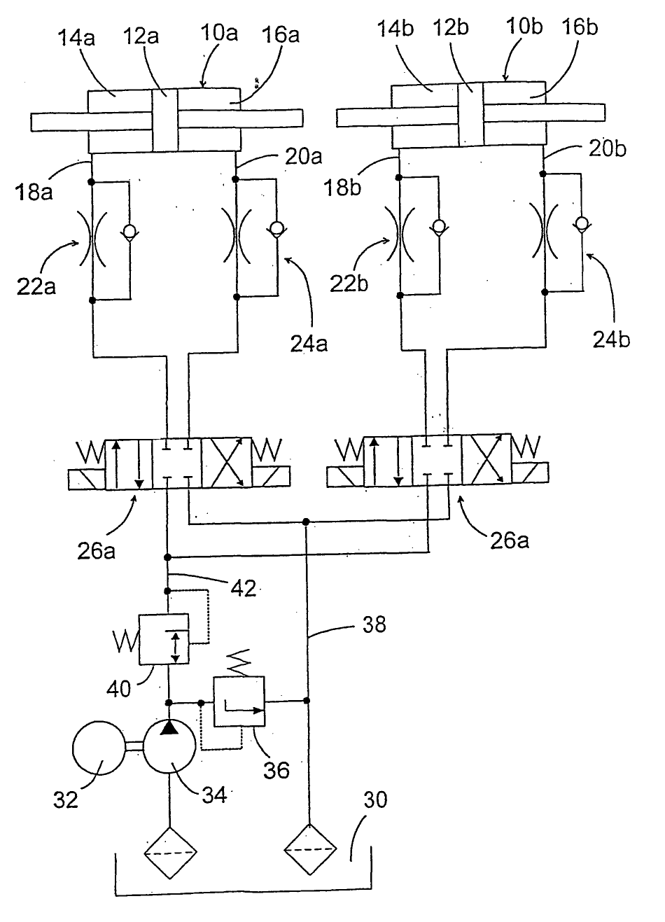

The present invention relates to a device according to the preamble of claim 1 for continuous unbalance adjustment in steerable vibration plates, having an actuating element that is formed as a piston of a hydraulic cylinder and that stands in a working connection with the associated unbalance mass, a storage unit for hydraulic fluid, and a pressure source that comprises a delivery pump for the hydraulic fluid.

Vibration plates that are suitable for use as soil compacting devices are set into vibration by rotating unbalance masses. Through rotation of the unbalanced masses relative to one another, it is known to modify the resulting forces that occur and their direction of action, and in this way to influence the travel speed of the vibration plate and its direction of motion. Up to now, the adjustment of the two unbalance masses has taken place using a respective single-acting hydraulic cylinder to which there is allocated a return spring in order to produce the restoring force. In this way, in theory the manipulated variable allocated to each hydraulic cylinder can be set arbitrarily by increasing the pressure in each of the two cylinders until the spring has undergone a defined shortening, in accordance with its spring characteristic, and, in this position on the piston that can be moved in the cylinder, creates an equilibrium between hydraulic force and spring force.

However, in practical operation, this equilibrium of forces is disturbed, and restoring moments are superposed on it that are neither constant nor linear and thus cannot be compensated. Causes of this can be for example restoring moments of the drive motor and/or reaction forces of the soil; an oscillation of the spring can occur, or effects of the inertia of the piston can become effective if the machine is exposed to extreme impacts.

In order to enable an exact controlling of a vibration plate, the object of the present invention is to enable a continuous adjustment of the unbalance masses, which are preferably situated on a common shaft, independent of external forces and moments. For this purpose, it is necessary to fix the piston operator in the adjustment cylinder much more rigidly than is possible with the conventionally used coil spring.

According to claim 1, the solution according to the present invention of this problem is that there is allocated to each adjustable unbalance mass a double-acting hydraulic cylinder having two fluid chambers, of which, for the displacement of a piston, the one can optionally be connected with the delivery pump, and at the same time the other can be connected directly with the storage unit, while, in order to fix the piston in its position, both fluid chambers can be sealed simultaneously against the storage unit and the pump.

Because the hydraulic fluid can be compressed only to a very slight degree, the closing of the lines results in the enclosing of the fluid in the line segments adjacent to the fluid chambers, with maintenance of the high pressure (35 to 40 bar) that prevails during the pump operation, whereby the pistons are fixed on both sides by an enclosed quantity of fluid under high pressure. The pistons cannot be moved from their set position by external effects, mass forces or restoring moments, because such external forces are not sufficient to overcome the existing fluid pressure. Here the possibility simultaneously arises of creating a closed control loop through the use of a suitable displacement-measuring device, which enables the realization of arbitrary defined curve radii, and even stationary compression.

Preferably, there is allocated to each double-acting cylinder a 4/3-way valve that is connected with a pressure fluid source, a fluid storage unit, and each of the two fluid chambers of the cylinder.

According to a particularly advantageous construction, each fluid chamber is connected with the 4/3-way valve via a throttle non-return valve.

The present invention is explained in more detail on the basis of the hydraulic circuit shown in the drawing.

The exemplary embodiment shows two double-acting hydraulic cylinders 10a and 10b, each of which acts as a servomotor in order to enable the optional and continuous adjustment, via a suitable mechanical connection, of the position of an unbalance mass, borne by a shaft, of a vibration plate between two end positions. In each of hydraulic cylinders 10a and 10b a piston 12a or 12b can be moved in linear fashion, and at the two sides of this piston there are situated fluid chambers 14a and 16a, or 14b and 16b. Each of the fluid chambers 14a to 16b has a line terminal 18a, 20a, or 18b, 20b, that leads, via a throttle non-return valve 22a, 24a, or 22b, 24b, to a respective 4/3-way valve 26a or 26b allocated to each of cylinders 10a and 10b.

Each of these 4/3-way valves 26a and 26b has four terminals and three positions. The position shown is the blocking position, in which line terminals 18a to 20b are interrupted.

When valve elements 28a or 28b are moved to the right, line terminals 18a and 18b are charged with pressure fluid that is delivered from a storage unit 30 by a pump 34 that can be driven by a motor 32. The delivery side of pump 34 is connected, via a pressure limiting valve 36, with a backflow 38 that leads to storage unit 30, and is connected with valves 26a and 26b via a pressure control valve 40 and a delivery line 42.

In this position of 4/3-way valves 26a and 26b, line terminals 20a and 20b are simultaneously connected with backflow 38.

Left fluid chambers 14a and 14b are charged with hydraulic fluid under pressure, which thereby moves pistons 12a and 12b to the right, thus displacing the fluid situated in fluid chambers 16a and 16b. All the displaced fluid must pass the throttle branches of valves 24a or 24b, which produces a resistance that brakes the piston motion in cylinders 10a and 10b. The speed of the motion of pistons 12a and 12 can be influenced by the dimensioning of the throttle branches and of the delivery pressure set at valve 40.

As soon as pistons 12a and 12b have reached the desired position, 4/3-way valve 26a or 26b is guided into the depicted blocking position, preventing further movement of fluid between 4/3-way valves 26a, 26b and cylinders 10a or 10b. Accordingly, pistons 12a or 12b are blocked in the position that they have assumed during the closing of valves 26a or 26b.

If the valve elements in 4/3-way valves 26a and 26b are moved to the left out of the blocking position, delivery line 42 is connected with right fluid chambers 16a and 16b, while left fluid chambers 14a and 14b are now connected with the backflow. In the drawing, pistons 12a and 12b then travel to the left until 4/3-way valves 26a or 26b are again brought into the blocking position.

The valve elements of 4/3-way valves 26a and 26b can be adjusted completely independently of one another, so that pistons 12a and 12b are also adjusted completely independently of one another.

1. Device for the continuous unbalance adjustment of steerable vibration plates, having
two adjustable unbalance masses situated on a common shaft,
a storage unit (30) for hydraulic fluid, and having
a pressure source comprising a delivery pump (34) for the hydraulic fluid, wherein
to each of the adjustable unbalance masses there is allocated a double-acting hydraulic cylinder (10a; 10b) having two fluid chambers (14a, 16a; 14b, 16b), and a piston (12a; 12b) that separates the fluid chambers (14a, 16a; 14b, 16b),
the piston (12a; 12b), as an actuating element, stands in working connection with an unbalance mass allocated thereto, and wherein
for the displacement of the piston (12a; 12b), one of the fluid chambers (14a, 16a; 14b, 16b) can optionally be connected with the delivery pump and at the same time the other can be connected directly with the storage unit (30), while, in order to fix the piston (12a; 12b) in its position, both fluid chambers (14a, 16a; 14b, 16b) can be sealed simultaneously against the storage unit (30) and the delivery pump (34).

2. Device as recited in claim 1, characterized in that there is allocated to each double-acting cylinder (10a; 10b) a 4/3-way valve that is connected with the delivery pump (34), the fluid storage unit (30), and each of the two fluid chambers (14a, 16a; 14b, 16b) of the cylinder.

3. Device as recited in claim 2, characterized in that each fluid chamber (14a, 16a; 14b, 16b) is connected with the 4/3-way valve (26a; 26b) via a throttle non-return valve (22a, 24a; 22b, 24b).

4. Device as recited in claim 3, characterized in that the throttle non-return valve (22a, 24a; 22b, 24b) has in a first passage a fluid throttle, and has, in a second passage connected in parallel to the first passage, a non-return valve.

5. Device as recited in one of claims 1 to 4, characterized in that including a path-measuring device, it forms a closed control loop.
